(19) United States
(12) Patent Application Publication
(10) Pub. No.: US 2022/0028053 A1
(43) Pub. Date: Jan. 27, 2022

(54) EXTRACTION AND COMPARISON OF ACTUAL AND TARGET SURFACE ATTRIBUTE VALUES

(71) Applicant: Hewlett-Packard Development Company, L.P., Spring, TX (US)

(72) Inventors: William J. Allen, Corvallis, OR (US); Qian Lin, Palo Alto, CA (US); Nathan Moroney, Palo Alto, CA (US)

(73) Assignee: Hewlett-Packard Development Company, L.P., Spring, TX (US)

(21) Appl. No.: 17/312,204

(22) PCT Filed: Mar. 19, 2019
(86) PCT No.: PCT/US2019/022868

§ 371 Date: Jun. 9, 2021

(51) Int. Cl. G06T 7/00; G06K 9/32; G06T 1/00

(52) U.S. Cl. CPC G06T 7/0004; G06T 1/0071; G06K 9/3241

(57) ABSTRACT

In one example in accordance with the present disclosure, an electronic system is described. The electronic system includes a scanning device to capture an image of an object. The object includes encoded data formed therein. An attribute determiner of the electronic system determines an actual value of a surface attribute of the object. The electronic system includes an extraction device to extract from the image of the object, a target value for the surface attribute from the encoded data. A comparator of the electronic system determines if a difference between the actual value and the target value has a specified value.

### BACKGROUND

Millions of products are produced and introduced into the economic stream every day. In some examples, logos or other symbols identify the products. The logos, symbols, and in some cases the products themselves, are produced according to specific standards and manufacturing specifications.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an electronic system for extracting and comparing actual and target surface attribute values, according to an example of the principles described herein.

FIG. 2 is a flow chart of a method for extracting and comparing actual and target values of surface attributes, according to an example of the principles described herein.

FIGS. 3A and 3B depict an extraction and comparison of actual and target surface attribute values, according to an example of the principles described herein.

FIG. 4 is a flow chart of a method for extracting and comparing actual and target values of surface attributes, according to another example of the principles described herein.

FIG. 5 depicts a non-transitory machine-readable storage medium for extracting and comparing actual and target surface attribute values, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As described above, millions of products are produced every day. Many of those products have surface attributes that provide a functional or aesthetic quality that a producer or distributor desires to maintain. For example, a truck bed may have a surface with a patterned texture that prevents slippage of individuals and/or material placed thereon.

In another example, the product itself, or a logo/symbol affixed to the product, may identify the product and may similarly have certain characteristics that a manufacturer desires to be consistent across all instances. For example, a company may have a corporate logo with a specific color. In this example, it may be desirable that each time the logo is reproduced, it bears that exact same color.

In other words, inspection and validation of a product, printed symbol, and/or digital symbol may be used for a variety of purposes including production process control and quality assurance activities. Over time, and due to variation between manufacturing methods, the logos, symbols, and/or products may not meet the standards and specifications. Sometimes, a producer may desire to exert product process control and quality assurance as a product, printed symbol, or digital symbol is used in the field, that is away from any physical or virtual facility of the producer.

In general, this may be done by comparing optical images of a product against corresponding digital specifications. As a specific example, in order to ensure color accuracy of a printed logo/symbol, a technician may have to visually inspect the logo and compare it against the digital specification. However, such a comparison may not be possible, or may be overly difficult. For example, the digital specifications may be unavailable or difficult to find. Moreover, such a physical comparison is prone to user error and therefore may not be reliable or accurate. Accordingly, such a comparison may be made, if made at all, after a lengthy procedure to acquire the digital specifications and may not even be a sound basis on which to make a determination of accuracy.

Accordingly, the present specification describes a system and method to provide such quality assurance and product control mechanisms. Specifically, the present specification describes a system whereby encoded data describing target attributes for an object, i.e., a product, printed image, digital image, is encoded directly in the object. An electronic system extracts this target attribute information and also acquires actual target attribute information by measuring the object itself. That is, data describing target values for a surface attribute are hidden within the object itself and when scanned by a scanning device can be used to determine a variation between actual values and the target value for the surface attribute.

The electronic system then compares the extracted target value information with the actual value information to determine a difference between the two. As will be described below, any number of remedial actions may then be taken, such as providing a notification to a user and/or automatically adjusting the manufacturing operation or display devices to adjust for any difference.

Specifically, the present specification describes an electronic system. The electronic system includes a scanning device. The scanning device captures an image of an object. The object itself includes encoded data formed therein. An attribute determiner of the electronic system determines an actual value of a surface attribute of the object. An extraction device of the electronic system extracts from the image of the object, a target value of a surface attribute. A comparator of the electronic system determines if a difference between the actual value and the target value has a specified value.

The present specification also describes a method. According to the method, encoded data formed in an object is extracted from an image of the object. From the encoded data, a target value of a surface attribute for the object is determined. According to the method, an actual value of the surface attribute of the object is measured and compared with the target value to determine surface attribute consistency.

The present specification also describes a non-transitory machine-readable storage medium encoded with instructions executable by a processor. The machine-readable storage medium includes instructions to determine, for an object, a target value of a surface attribute of the object. The machine-readable storage medium also includes instructions to encode the target value into a surface attribute pattern to be formed on the object. The machine-readable storage medium also includes instructions to form the surface attribute pattern into the object.

In summary, using such a system 1) provides control of a manufacturing process, especially in environments where it is not feasible to match production specification data with measured attributes of produced components; 2) qualifies component attributes in the field where it is not feasible to match production specification data with measured attributes of said components; 3) may be done without creating physical artifacts that may be visually undesirable; and 4) allows accurate reproduction of sensed items, for example color of a corporate logo on a poster captured by a smartphone camera under uncontrolled illumination conditions. However, the devices disclosed herein may address other matters and deficiencies in a number of technical areas.

As used in the present specification and in the appended claims, the term “object” refers to any physical object or digital representation of a component which has a surface attribute and which itself stores encoded data. For example, the object may be a physical object which may include a printed symbol/logo. The object may also be a digital object such as an image, such as a logo/symbol displayed on a computing device screen.

Further, as used in the present specification and in the appended claims, the term “acceptability condition” refers to an actual value of a surface attribute having a satisfactory value based on any number of criteria. For example, the acceptability condition may be a lower-limiting threshold value, an upper-limiting threshold value, or outside of a threshold range. In yet another example, an acceptability condition may have a bi-modal criterion. For example, acceptable values for L* in a CIELAB color scheme may be between 41 and 46 or between 69 and 71. In such an example, the acceptable resulting color may be a middle grey (a grey that looks about ½ way between a black patch and a white patch), and also a lighter grey is acceptable. This could correspond to an older and a newer version of the grey background on a company logo being acceptable, but other values being unacceptable.

Further, as used in the present specification and in the appended claims, the term “steganographic” data or information refers to data encoded as 2D and 3D steganographic patterns.

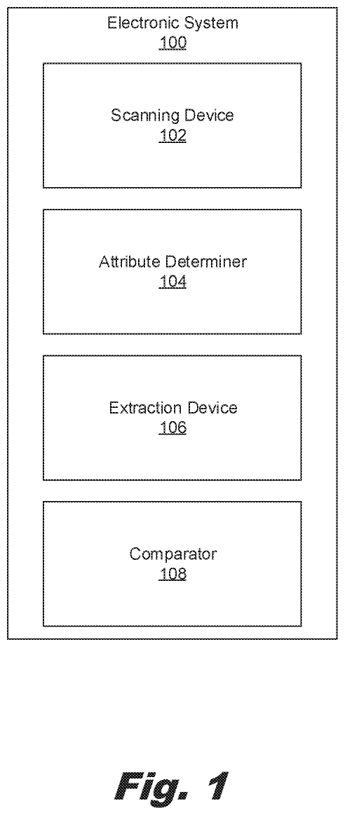

Turning now to the figures, FIG. 1 is a block diagram of an electronic system (100) for extracting and comparing actual and target surface attribute values, according to an example of the principles described herein. In some examples, the electronic system (100) may be formed in a single electronic device. The electronic device may be of a variety of types. Examples of electronic devices include laptop computers, personal digital assistants (PDAs), mobile devices, notebooks, tablets, gaming systems, and smartphones among other electronic devices. In other examples, the electronic system (100) may be distributed, meaning that different components are on different devices. For example, one device may include any combination of a scanning device (102), extraction device (106), and comparator (108) while an attribute determiner (104) may be on a separate device.

The electronic system (100) includes a scanning device (102) to capture an image of an object. Specifically, the scanning device (102) captures encoded data associated with the object. In some examples, the encoded data is formed on a surface of the object, in other examples, the encoded data is formed inside the object. As an example, an object such as a manufactured product, printed image, or digital image may be encoded with a data payload on the surface of the object. The data may be stored and hidden, or encoded, on the object in any number of ways. For example, the data may be visually imperceptible or may be identified by close inspection and yet be in a format unreadable to humans. That is, the data may not include alphanumeric characters and may instead encode data based on any number of non-alphanumeric fashions including color patterns, raised/unraised surface patterns, and surface texture characteristics. In another example, steganographic data may be included as the encoded data. That is, data being encoded as 2D and 3D steganographic patterns may be formed on the object. Accordingly, the scanning device (102) acquires an image of the object on which this data is encoded and disposed.

In another example, as mentioned above, the encoded data may be inside the object. For example, a black bar code may be printed on an otherwise white object. This layer may be covered with a thin layer of white plastic or paint. In this example, under low light conditions, the bar code would be difficult or impossible to see under low light levels through the thin layer of white plastic or paint. However, when a bright light was put onto the object, the black bar code just below the surface would become visible.

In these examples, the encoded data is optical. In other examples, the data may be encoded in another form. For example, the encoded data may be formed on a radio frequency identification (RFID) tag embedded inside the object, or adhered to the object. In this example, the encoded data is in the form of radio-frequency energy.

The scanning device (102) may be of a variety of types. For example, the scanning device (102) may simply be a camera disposed on a smartphone, which camera takes a picture of the object. The scanning device (102) may be of other types such as an optical scanner, a laser scanner, and a radio-frequency transceiver among others.

As described above, in some examples the encoded data may be visually imperceptible to individuals. In these examples, the scanning device (102) captures images that are not visible to humans. As a specific example, a printed image may include layers of ink that are transparent to visible wavelengths of light and yet absorb infrared wavelengths. Such inks may be used to print a pattern that is invisible to the human eye, or otherwise visually imperceptible. In this example, the scanning device (102) may be an infrared camera/illumination system that can detect the infrared pattern on the printed image.

In another example, the object includes a pattern of raised surfaces. In these examples, data may be encoded on the raised surfaces. That is, the orientation, shape, and or height of the different surfaces may be detected with different angles, shapes, and/or heights mapping to different bits. Accordingly, in this example, the scanning device (102) may include an optical light-based scanner that can detect, via light beams or other detectors, the angles, shapes, and/or heights such that the encoded data mapped to these characteristics can be extracted.

As yet another example, the encoded data may be represented by slight changes to color of a printed symbol in certain areas. In this example, a user, upon very close inspection, may be able to detect the changes in color. For example, the mottling included in the image may be subtle, and most pixels within the object may have values within a narrow band of digital counts. In this manner, an encoding device adjusts the values of certain pixels to encode the frequency-domain data payload as a low-visibility watermark within the object.

However, even in the event an individual could detect the changes in color, the data may be encoded in a format unreadable to humans, for example with differences in pixel color, such that an individual would not be able to decipher the data. In other examples, the data may be readable. For example, if the object in question is a brake rotor for a car, it may be sufficient to encode a surface roughness characteristic for that brake rotor in a manner that is readable, or noticeable, by humans.

Thus, in summary, while a user may be able to detect a difference in the object in the region where the data is encoded, in some cases the user would not generally be able to decipher the encoded data. That is, the encoding may not rely on alphanumeric characters, but may be encoded any number of other ways including mottling of the color, surface characteristics of a raised texture, etc. In this example, the scanning device (102) may be able to discern the patterns in color and/or texture and then may pass them to another component for extraction of data based on the detected differences.

While specific reference is made to particular forms of the encoded data, the encoded data may take many forms which may be included in the physical structure of the object itself. For example, the encoded data may take the form of a pattern of shapes, an alteration of color, pattern and characteristics of raised and unraised sections.

The electronic system (100) includes an attribute determiner (104) to determine an actual value of a surface attribute of the object. That is, an object, be it physical or digital includes surface attributes that characterize it. For any number of reasons such as manufacturing variance or time-based wear, the surface attributes may vary from a desired target value. Determining the actual value of the surface attribute allows for a comparison against any target value.

That is, the encoded data in the object may include target values for different surface attributes, for example as dictated by a specification or standard. The attribute determiner (104) determines the actual values of surface attribute of the object for comparison against the target values.

The attribute determiner (104) may be of a variety of types and may be selected based on the surface attribute to be measured and compared. For example, the surface attribute may be an object color, object hardness, object surface roughness, object coefficient of friction, surface texture, surface gloss, surface translucence and/or a surface dimension. Accordingly, the attribute determiner (104) may take any variety of forms to measure the particular surface attribute.

For example, then the surface attribute of interest is an object color, the encoded data may include target color coordinates measured under predefined conditions. In this example, the attribute determiner (104) acquires the actual value for surface attribute from the image of the object. That is, the attribute determiner (104) may be able to extract the color coordinates of the object, be it digital or physical, from the image itself.

As a specific example, a corporate logo may have a very specific hue of the color red as an identifying feature of their logo. As has been described, color coordinates for this very specific hue may be encoded into the logo itself. Accordingly, upon replication, a user with the scanning device (102) may take an image of the logo. In this example, the attribute determiner (104) may extract the actual color coordinate of the color of the logo. As will be described below, this actual value can be compared against the target value to determine how the display/production of the physical or digital image differs from the target values indicated in the encoded data in the image itself.

In the example where the surface attribute is a surface hardness, the attribute determiner (104) may include a device for determining surface hardness. That is, the attribute determiner (104) may be a rod that is pushed against the surface. The hardness of the surface is based on the characteristics of the protrusion as well as the level of penetration into the surface material.

In another example, the surface attribute may be a surface roughness or other surface texture. In these examples, the attribute determiner (104) may be a profilometer that measure the surface topography to determine surface roughness and/or texture.

In yet another example, the surface attribute may be a coefficient of friction of the object surface. In this example, attribute determiner (104) may be of any variety of materials pulled across the surface to determine the surface coefficient of friction.

In yet another example, the surface attribute may be a surface dimension. In this example, the attribute determiner (104) may be able to acquire surface dimension information directly from the image. For example, the attribute determiner (104) may, using image analysis tools, determine a size of an object based solely on an image of the object. In another example of determining a surface dimension, the attribute determiner (104) may include a probe that can physically measure the actual dimensions of the object.

While specific reference is made to a few examples of surface attributes and attribute determiners (104), it should be noted that any variety of surface attributes may be determined by different types of attribute determiners (104).

The electronic system (100) also includes an extraction device (106) to extract from the image of the object, a target value for the surface attribute for the object from the encoded data. That is, as described above, the encoded data may include information that describes a desired, or target, surface attribute value for an object, whether that surface attribute relates to an object color, surface roughness, thickness, hardness, or any of the above-mentioned, or other, surface attributes. This value may be encoded in any number of fashions as described above including, but not limited to, color mottling, raised texture patterns and/or characteristics and any number of other fashions. The extraction device (106) may be able to detect these color differences and/or texture patterns. The extraction device (106) also includes a mapping between the particular pattern and bits of data such that when a particular color pattern is detected, the extraction device (106) may discern an associated bit, or set of bits, with that color pattern. By repeating this action, a string of data bits can be re-created from a pattern in the color mottling, texture patterns, etc. In one specific example, it may be the case that two bits are to be encoded in the object. In this example, one shape such as a star may represent 0, a square may represent a 1, a circle may represent a 2 and a triangle may represent a 3. In other words, the scanning device (102) may scan an image of the object. The extraction device (106) identifies the pixel values at each location and references a database to decipher the data based on the associated pixel values.

In another example, the scanning device (102) may include an optical scanner that can detect a size, shape, height, and angle of raised textures on a surface and pass the information relating to these characteristics to the extraction device (106) which may extract the target surface information therefrom.

A comparator (108) then determines a difference between the actual value of the surface attribute (as collected by the attribute determiner (104)) and the target value of the surface attribute (as collected from the scanning device (102) and extracted by the extraction device (106)). The results of the comparison will identify whether the actual value is outside of acceptability conditions for the target value. That is the target value may be a lower-limiting threshold where any actual value less than this lower-limiting threshold is deemed inadequate. In another example, the target value may be an upper-limiting threshold where any actual value greater than this upper-limiting threshold is deemed inadequate. In yet another example, the target value may be multiple values that define a threshold range where any actual value outside of the threshold range is deemed inadequate. In yet another example, multiple ranges may be used. For example, an actual value may be acceptable when found between either a first range or a second range. Accordingly, comparison of the actual value of the surface attribute with any of these types of target values determines whether the object is outside of predetermined acceptability conditions, that is whether it is unacceptable and whether remedial action should be taken.

A few specific examples are now provided. In this example, the surface attribute is a color coordinate in the RGB coordinate plane. In this example, the scanning device (102) captures an image of an object such as a product label. Encoded in the product label is the target color coordinate values of red 100, green 180, and blue 200. This information may be encoded by mottling the product label in a nearly indiscernible fashion. The extraction device (106) may take the captured image and analyze the mottling to extract the target color coordinate values.

The attribute determiner (104) may also operate to determine the actual color coordinates of the product label. In this example, the attribute determiner (104) may analyze the image to determine the actual color coordinates values of the product label at a predetermined location are red 50, green 120, and blue 200. Accordingly, the comparator (108) may compare the target values with the actual values to determine a difference therebetween.

More specifically, the comparator (108) may determine whether the difference is within specified values or whether it is out of bounds. In some examples, the specified values may be a range. That is, whether the actual values are within a certain percentage of the target values. In another example, the specified values may be single-bounded. That is, it may be determined whether an actual value is greater than a target value, or less than a target value, which may indicate is satisfactory alignment with a target value.

As another specific example, the surface attribute is a color coordinate in the CIELAB color space. In this color space 3 parameters, L*, a*, and b* are used to specify a color. In this example, the target values may be L* 69, a* −21, and b* −18. This information may be encoded into the product label in any number of fashions and extracted by the extraction device (106).

The attribute determiner (104) may also operate to determine the actual color coordinates of the product label. In this example, the attribute determiner (104) may analyze the image to determine the actual color coordinates values of the product label at a predetermined location are L* 49, a* −1, and b* −49. Accordingly, the comparator (108) may compare the target values with the actual values to determine a difference therebetween.

As described above, the acceptability conditions may be of any type. In this example, it may be the case that the target color is L* a* b* (40, −4, 12) with an acceptability tolerance of 3 delta-E. Any color triple that is less than or equal to 3 units of distance (Euclidian formula) from the desired color may be satisfactory. Accordingly, it may not be sufficient to indicate that an actual L* value is acceptable if it is between 38 and 42 because the measured color might be L* a* b* (40, −4, 20). Accordingly, in this example, the target and actual L* values match, the target and actual a* values match, but the actual b* is 8 units too large, and the Euclidian distance from the target color to the actual color is 8. Accordingly, in this example, an acceptability condition is determined and used to analyze the actual value to determine whether the actual color is acceptable or not.

Thus, the present electronic system (100) provides for a comparison of surface attributes of the object with target values that are included on the object itself. Thus, rather than consulting an unavailable, or difficult to obtain standard, the standard against which actual values are compared against are included in the object itself. Moreover, such an authentication system does not rely on visual inspection, which is prone to user error and may not be reliable nor accurate. Thus, the electronic system (100) provides machine readable data-bearing objects that are not objectional to the eye, do not disfigure a surface, are hidden, and that allow the object to retain its aesthetic qualities.

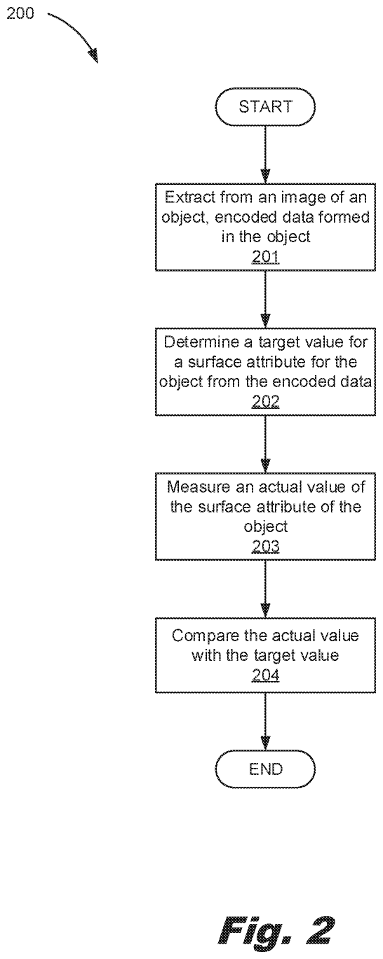

FIG. 2 is a flow chart of a method (200) for extracting and comparing actual and target values of surface attributes, according to an example of the principles described herein. According to the method (200), encoded data formed on or in an object is extracted (block 201) from an image of the object. That is, an object may be encoded with data that is indicative of different desired, reference, or target surface attribute values. As described above, the data may reference any variety of surface attributes such as color, surface roughness, thickness or other dimension, texture pattern, and coefficient of friction among others. While specific reference is made to a few attributes, any attribute of the object may have a target value that is encoded in the object itself. The data may be encoded in any fashion including as mottling to an object color, as a particular pattern, size, shape, height, and/or orientation of surface features. While specific reference is made to a few particular methods of encoding the data in an object, other methods may be used to encode the data in the object.

In some examples, the information is extracted (block 201) from the image itself. That is, the data encoded in the object may be the actual target values. In other examples, the extraction may be from a different location. That is, the encoded information may include a pointer, such as a uniform resource locator (URL), to a location on a remote server where the target values are located. In this example, extracting (block 201) the target value encoded data includes extracting (block 201) the information from a location identified by a pointer in the encoded data. With the encoded data extracted (block 201), a target value for the surface attribute for the object is determined (block 202) from the encoded data. That is, the data in its encoded form, is decoded such that the target value information can be processed. As described above, this may include decoding a series of bits from the encoded data itself, which bits indicate the target surface attribute values. In another example, this may include directing the electronic system (FIG. 1, 100) browser to a location identified by a pointer which is included in the encoded data. In either case, the target value for the surface attribute is determined (block 202).

In addition to determining (block 202) the target value, an actual value for the surface attribute is also determined. Specifically, an attribute determiner (FIG. 1, 104), which may take many forms, measures (block 203) an actual value for the surface attribute of the object. In some examples, such measurements may be done on the image, such as for example color, or dimensional measurements. In other examples, measuring (block 203) the actual values of the surface attributes includes physically interacting with the object, such as with a probe, or profilometer, or durometer to physically measure (block 203) different actual values of the surface attributes.

The actual value and the target value of the surface attribute are then compared (block 204) to determine surface attribute consistency. That is, it may be determined if the actual measured surface attribute of the object is within any number of predefined ranges of a desired value, greater than a threshold value, or less than a threshold value. If the actual value is not within specified values, then it may be determined that the object is non-conforming with acceptability conditions, or out of bounds. In which case, certain remedial actions may be taken.

In some cases, the method (200) may be performed during production of the object. For example, a corporate logo may be printed. During initial printing, the printed output of the logo may be analyzed to determine if it is within a target, reference, expected, or desired logo color.

In another example, the method (200) may be performed during the use of the product. For example, overtime, a desired surface pattern of an object may wear down. Accordingly, in this example, the used object may be analyzed to determine if the actual surface pattern characteristics are within an acceptable range, which acceptable range may be a safety range. In both the post-manufacturing and field cases just noted, such conformance with a target value may be done without reference to an original component specification to obtain a knowledge about the part's status and suitability for purpose.

Thus, the present specification describes a method (200) wherein control over manufacturing processes may be maintained in situations where it may not be feasible to match production specification data with measured attributes of produced components. For example, in the case where production specification data is not available or is not desired to be disseminated to manufacturing subcontractors.

The method (200) also allows qualification of component attributes in the field where it is not feasible to match production specification data with measured attributes of said components. As described above, in some examples, the encoded data is hidden, such that there are no physical artifacts that may be visually undesirable. Moreover, the target values may be specifically encoded on the object, thus eliminating the storage of such target values on an electronic device, thus freeing up device memory storage. Storing the specs in an encoded, unreadable (to humans) format also allows component specifications to remain unpublished and therefore protected, while still enabling sophisticated validation of physical attributes after manufacture based on those specifications.

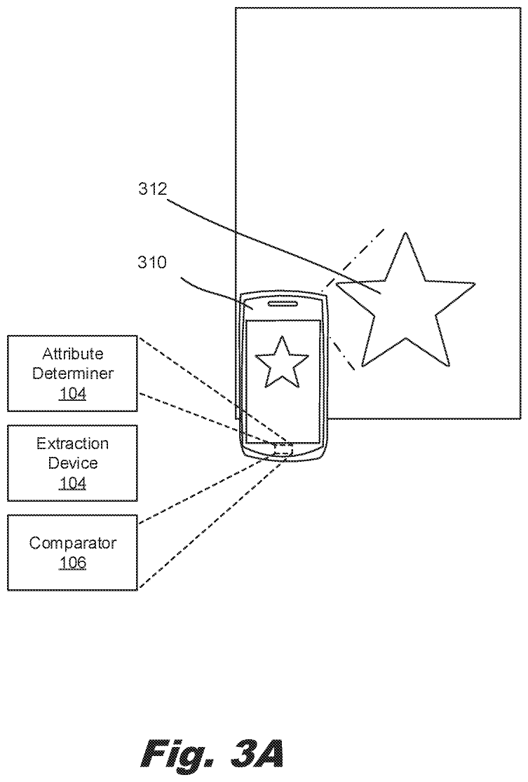

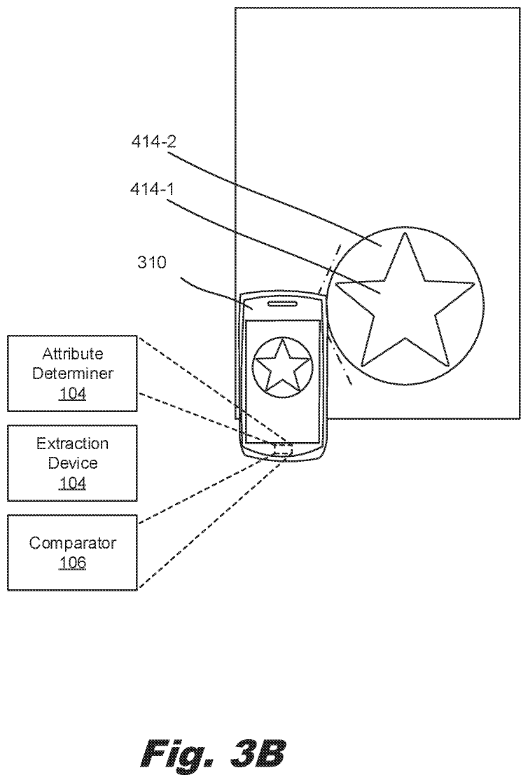

FIGS. 3A and 3B depict an extraction and comparison of actual and target surface attributes values, according to an example of the principles described herein. In the example depicted in FIGS. 3A and 3B, the object is a printed glyph (312) in the form of a star. While FIGS. 3A and 3B depict the object as being a physical object, as described above, the object may be a digital object such as an image of an object or a scene on the electronic system (FIG. 1, 100). In either case, the electronic system (100) captures an image of the object. In the example depicted in FIGS. 3A and 3B, the electronic system (FIG. 1, 100) is a mobile phone (310), and the scanning device (FIG. 1, 102) may be the camera that is disposed on the mobile phone (310). An attribute determiner (104) then determines an actual surface attribute value. For example, the attribute determiner (104) on a mobile phone (310) may be a device that can measure the surface attribute of the glyph (312), whether that glyph (312) is printed on a physical media or displayed on a screen such as a display screen or a projector screen in a theater. In some examples, the measurement device may be the scanning device (FIG. 1, 102), or camera, itself. In other examples, the measurement device may be a separate component. As a specific example, the camera, or other sensors in the mobile phone (310) can measure the color coordinates of the glyph (312). The extraction device (104) can then extract the target surface attribute value from the image of the object. As described above, in some examples the encoded data is visually imperceptible, or hidden. In this case, the scanning device (FIG. 1, 102) may include some component to read the visually imperceptible encoded data. Also, as described in some examples, the encoded data is difficult to discern. For example, the encoding may be via a mottling of the colors that make up the glyph (312) or may be encoded in another format that is unreadable to humans.

The comparator (106) of the mobile phone (310) can then compare these two pieces of information, i.e., the target value extracted from the glyph (312) and the measured value of the glyph (312).

In some examples, the encoded data is located at just a particular region of the object, for example, a particular region of the glyph (312). In other examples, the encoded data is repeated across the object. Repeating the encoded data across the object simplifies the scanning of the encoded data and also allows for scanning of the encoded data in the event a portion of the object is destroyed or otherwise inaccessible.

FIG. 3B depicts an example, where multiple regions (414-1, 414-2) of the object are processed. For example, the object may include a first region (414-1) shaped as a star in the example of FIG. 3B and a second region (414-2) in the shape of a circle surrounding the star. In general, a particular object may have multiple surface attributes or multiple regions that have different values of a particular surface attribute. It may be desirable that each instance of a particular surface attribute be monitored such that a producer can have greater certainty and control regarding the quality and characteristics of any generated object. Accordingly, it may be desirable to measure the surface attribute values of various regions (414), and to compare these measured values against respective target values for those regions.

Accordingly, in this example, using methods described above, the attribute determiner (104) determines actual values for surface attributes for multiple regions of the object (FIG. 3, 312) and the extraction device (104) extracts target values for each of the multiple actual values. That is, each region (414) may have embedded therein target values for that region (414) and the extraction device (104) thereby extracts the respective target values. In another example, a single region may have embedded therein target values for that region (414) and another region (414).

In either case, the comparator (106) determines differences between the respective actual values as measured in the different regions (414) with their associated target values. Thus, each area of the object that has an attribute that a producer desires to exert manufacturing control over, has a target attribute stored therein for quality assurance or manufacturing control.

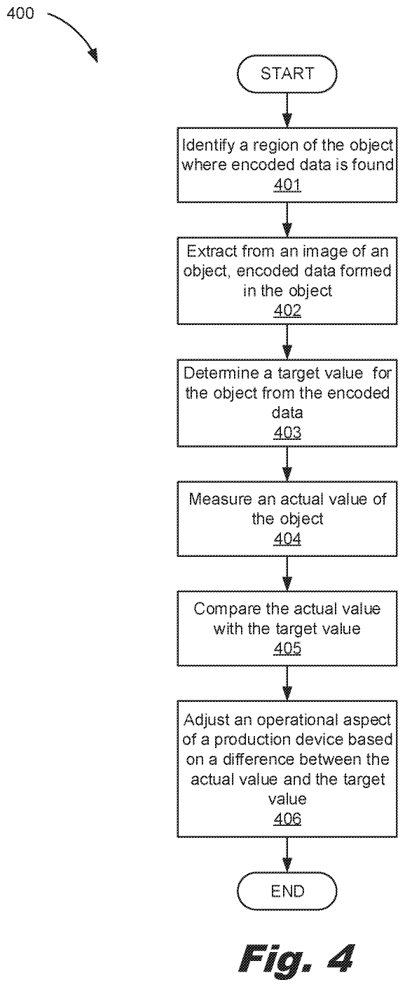

FIG. 4 is a flow chart of a method (400) for extracting and comparing actual and target values of surface attributes, according to another example of the principles described herein. According to the method (400), a region (FIG. 4, 414), or regions (FIG. 4, 414) of the object for which a surface attribute is to be controlled is identified. That is, an object may have many different regions (FIG. 4, 414), each with different surface attribute values. A producer may desire to control particular surface attributes of a subset, or all, of these regions (FIG. 4, 414). In this example, a digital payload describing target surface attribute values for these regions (FIG. 4, 414) is created. That is, the data describing the particular target values is created or a pointer to a location where the particular target values are stored is compiled as a data payload. This information is then encoded in the object in a manner which is hidden. Note that the data payload, as described above, describes a target value or range of values for the attribute to be controlled.

Returning to the example where data is encoded via color mottling. In this example, an encoder may adjust a number of characteristics of the image. For example, pixel values may be slightly altered, which alteration value is indicative of a bit of information, which when extracted serves to communicate the data payload, i.e., the target surface attribute value or a pointer to the target surface attribute value, to the electronic system (FIG. 1, 100).

Similarly, in an example where the payload is encoded into raised/unraised portions of a surface pattern, an encoder may adjust a number of characteristics of the raised surfaces, such as a height, shape, size, and/or orientation of the raised portions. The height, shape, size, and/or orientation of the raised portions may be indicative of a bit of information, which when extracted serves to communicate the data payload, i.e., the target surface attribute value or a pointer to the target surface attribute value, to the electronic system (FIG. 1, 100).

When received, the encoded data may be extracted (block 402) from the object and a target value determined (block 403) from the extracted encoded data. This may be performed as described above in connection with FIG. 2.

As described above, in some examples, the encoded data is repeated across the object. However, in other examples, the encoded data may just be present in a particular region of the object. Accordingly, a region of the object where the encoded data is found is identified (block 401).

In one particular example of identifying (block 401) the region of the object where the data is encoded, an image may be analyzed piece-wise in the frequency domain to identify a signature that indicates likely encoded information. A decoding operation may then be executed in the region of this signature. The data encoded in these examples may include extra error detection and correction bits. Accordingly, upon decoding, one can be confident that either there is data stored in that area or that in spite of a frequency domain signature consistent with encoded information, no encoded information was found. It may also be the case that for certain objects, the encoded data may be placed in a predetermined location. For example, if the object is a model car, the encoded data may be placed on the hood of the car.

Once the region where the encoded data is identified (block 401), if the encoded data is not repeated over the object, encoded data is extracted (block 402), a target value determined (block 403), actual surface attribute values are measured (block 404) and compared (block 405) against the target values to determine attribute consistency. These operations may be performed as described above in connection with FIG. 2.

In some examples, an operational aspect of a production device is adjusted (block 406) based on a difference between the actual value and the target value. That is, if the actual value of the surface attribute is outside of certain acceptability conditions, which may be a predetermined range, greater than a threshold value, or less than a threshold value, a production device of the object may be altered (block 406).

Such an alteration may take many forms. For example, in the case of an image of an object as displayed on a computing device, a display of the computing device, or the electronic system (FIG. 1, 100), may be calibrated based on a difference between the actual measured value of the surface attribute and a target value for the image. For example, a digital scene of a landscape with a lake may be produced in which calibration information is encoded on a portion of the scene that depicts the lake. Later, an image of the landscape might be captured under unknown illumination conditions. The encoded data, i.e., the target color information, is extracted and all colors in the reproduced image can be corrected to some extent based on the lake as a calibration target. Such a calibration may be done without accessing the original color coordinates for the object, i.e., the landscape image, and without needing to recognize the object. Thus, the present method (400) allows for the accurate reproduction of sensed items, for example color of a corporate logo on a poster captured by a smartphone camera under uncontrolled illumination conditions. That is, a captured digital photo containing the object could be processed, the encoded area detected and decoded, and any subsequent reproduction of that captured image could have the color of the object in question reproduced accurately.

In the case of a physical printed object, the printing system that prints the printed object may be adjusted (block 406) based on a difference between the actual value and the target value. Returning to the example of a scene of a landscape with a lake in which calibration information is encoded on a portion of the scene that depicts the lake. In this example, rather than calibrating the computing screen, the printing device may be adjusted such that a printed version of the landscape matches a color profile desired for the image, such that the colors may be accurately reproduced to manufacturer specifications. Again, doing so may be done without accessing the original color coordinates for the object, i.e., the landscape image, and without needing to recognize the object.

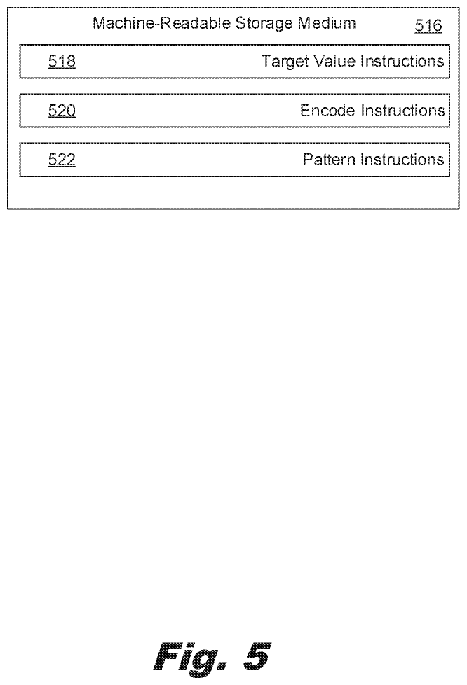

FIG. 5 depicts a non-transitory machine-readable storage medium (516) for extracting and comparing actual and target surface attributes, according to an example of the principles described herein. To achieve its desired functionality, a computing system includes various hardware components. Specifically, a computing system includes a processor and a machine-readable storage medium (516). The machine-readable storage medium (516) is communicatively coupled to the processor. The machine-readable storage medium (516) includes a number of instructions (518, 520, 522) for performing a designated function. The machine-readable storage medium (516) causes the processor to execute the designated function of the instructions (518, 520, 522).

Referring to FIG. 5, target value instructions (518), when executed by the processor, cause the processor to determine, for an object, a target value of a surface attribute of the object. Encode instructions (520), when executed by the processor, may cause the processor to, encode the target value into a surface attribute pattern to be formed on the object. Pattern instructions (522), when executed by the processor, may cause the processor to form the surface attribute pattern onto the object.

In summary, using such a system 1) provides control of a manufacturing process, especially in environments where it is not feasible to match production specification data with measured attributes of produced components; 2) qualifies component attributes in the field where it is not feasible to match production specification data with measured attributes of said components, 3) may be done without creating physical artifacts that may be visually undesirable; and 4) allows accurate reproduction of sensed items, for example color of a corporate logo on a poster captured by a smartphone camera under uncontrolled illumination conditions. However, the devices disclosed herein may address other matters and deficiencies in a number of technical areas.

What is claimed is:

1. An electronic system, comprising:
a scanning device to capture an image of an object, the object including encoded data formed therein;
an attribute determiner to determine an actual value of a surface attribute of the object;
an extraction device to extract from the image of the object, a target value for the surface attribute from the encoded data; and
a comparator to determine if a difference between the actual value and the target value has a specified value.

2. The electronic system of claim 1, wherein the scanning device captures an image of at least one of:
a physical object; and
an object displayed on a display screen.

3. The electronic system of claim 1, wherein the actual value of the surface attribute is acquired from the image.

4. The electronic system of claim 1, wherein the encoded data is visually imperceptible.

5. The electronic system of claim 1, wherein the surface attribute comprises at least one attribute selected from the group consisting of:
an object color;
an object hardness;
an object surface roughness;
an object coefficient of friction;
a surface texture;
a surface gloss;
a surface translucence; and
a surface dimension.

6. The electronic system of claim 1, wherein the encoded data is repeated across the object.

7. The electronic system of claim 1, wherein:
the attribute determiner determines actual values of surface attributes for multiple regions of the object;
the extraction device extracts target values for each of the multiple regions; and
the comparator determines differences between actual values and target values for each of the multiple regions.

8. A method, comprising:
extracting from an image of an object, encoded data formed in the object;
determining a target value of a surface attribute for the object from the encoded data;
measuring an actual value of the surface attribute of the object; and
comparing the actual value with the target value to determine surface attribute consistency.

9. The method of claim 8, wherein determining a target value of a surface attribute for the object from the encoded data comprises at least one of:
extracting the target value from the encoded data; and
extracting the target value from a location indicated by a pointer found in the encoded data.

10. The method of claim 8, further comprising adjusting an operational aspect of a production device when the difference is at least one of:
outside of a predetermined threshold; and
outside of a predetermined range.

11. The method of claim 10, wherein:
the object is an image displayed on a display of a computing device; and
adjusting an operational aspect of a production device comprises calibrating the display of the computing device based on a difference between the actual value for the image and the target value for the image.

12. The method of claim 10, wherein:
the object is a printed image; and
adjusting an operational aspect of a production device comprises adjusting a printing system based on a difference between the actual value for the printed image and the target value for the printed image.

13. The method of claim 7, further comprising identifying a region of the object where the encoded data is found.

14. A non-transitory machine-readable storage medium encoded with instructions executable by a processor, the machine-readable storage medium comprising instructions to:
determine, for an object, a target value of a surface attribute of the object;
encode the target value into a surface attribute pattern to be formed on the object; and
form the surface attribute pattern onto the object.

15. The non-transitory machine-readable storage medium of claim 14, wherein the encoded data is formed on the object during manufacturing of the product.
